(19) United States
(12) Patent Application Publication
(10) Pub. No.: US 2026/0252173 A1
(43) Pub. Date: Aug. 27, 2026

(54) TACTILE FEEDBACK METHOD AND APPARATUS

(71) Applicants: Beijing BOE Technology Development Co., Ltd., Beijing (CN); BOE Technology Group Co., Ltd., Beijing (CN)

(72) Inventors: Yongchun TAO, Beijing (CN); Yuju CHEN, Beijing (CN); Yingzi WANG, Beijing (CN)

(21) Appl. No.: 18/992,198

(22) PCT Filed: Mar. 18, 2024
(86) PCT No.: PCT/CN2024/082178

§ 371 Date: Jan. 8, 2025

(30) Foreign Application Priority Data
Apr. 21, 2023 (CN) 202310436463.1

(51) Int. Cl. G06F 3/01; B06B 1/02; G06F 3/041

(52) U.S. Cl. CPC G06F 3/016; B06B 1/0215; G06F 3/0416; B06B 2201/55

(57) ABSTRACT

A tactile feedback method and apparatus. The tactile feedback apparatus comprises a controller, a waveform processor, a piezoelectric driver and a touch panel, and the tactile feedback apparatus further comprises a virtual functional area; the controller comprises a waveform generator; the touch panel is configured to detect touch position information of user interactions, and output the touch position information to the controller; the controller is configured to determine whether the touch position information is in the virtual functional area, and if the touch position information is in the virtual functional area, control the waveform generator to generate an excitation signal and output same to the waveform processor; the waveform processor is configured to perform amplification processing on the excitation signal and output the processed signal to the piezoelectric driver; the piezoelectric driver is configured to receive the processed signal and deform, so as to drive the touch panel to vibrate.

### CROSS-REFERENCE TO RELATED APPLICATIONS

The present application is a U.S. National Phase Entry of International Application PCT/CN2024/082178 having an international filing date of Mar. 18, 2024, which claims priority to Chinese Patent Application No. 202310436463.1 filed to the CNIPA on Apr. 21, 2023 and entitled “Tactile Feedback Method and Apparatus”, and the contents disclosed in the above-mentioned applications are hereby incorporated as a part of this application.

### TECHNICAL FIELD

Embodiments of the present disclosure relate to, but are not limited to, the technical field of touch control, and particularly relate to a haptic feedback method and apparatus.

### BACKGROUND

The multi-mode fusion of vision, hearing and touch is of great significance and value to enhance the safety and effectiveness of operation and enrich the user experience. Current visual and auditory presentation technologies are mature and rich, but haptic feedback is still not rich and realistic enough.

At present, electronic products such as mobile phones and wearable devices mainly generate vibration feedback through low-frequency vibration of Eccentric rotating mass (ERM) (commonly called vibration motor) and Linear Resonance Actuator (LRA), and the effect is relatively simple and single, far from meeting user expectations.

### SUMMARY

The following is a summary of subject matters described herein in detail. This summary is not intended to limit the protection scope of claims.

An embodiment of the present disclosure provides a haptic feedback apparatus, including a controller, a waveform processor, a piezoelectric driver, and a touch panel, and the haptic feedback apparatus further includes a virtual function region, wherein the controller includes a waveform generator;
the touch panel is configured to detect touch position information of user interaction and output the touch position information to the controller;
the controller is configured to determine whether the touch position information is in the virtual function region, and if the touch position information is in the virtual function region, the controller controls the waveform generator to generate an excitation signal and output it to the waveform processor;
the waveform processor is configured to amplify the excitation signal and output the processed signal to the piezoelectric driver; and
the piezoelectric driver is configured to receive the processed signal and generate deformation to drive the touch panel to vibrate.

An embodiment of the present disclosure also provides a haptic feedback method for a haptic feedback apparatus, wherein the haptic feedback apparatus includes a controller, a waveform processor, a piezoelectric driver, and a touch panel, the haptic feedback apparatus further includes a virtual function region, the controller includes a waveform generator, and the haptic feedback method includes:
detecting touch position information of user interaction through the touch panel, and outputting the touch position information to the controller;
determining whether the touch position information is in the virtual function region through the controller, and if the touch position information is in the virtual function region, controlling the waveform generator through the controller to generate an excitation signal and outputting it to the waveform processor;
amplifying the excitation signal through the waveform processor and outputting the processed signal to the piezoelectric driver;
wherein the piezoelectric driver receives the processed signal and deforms, thereby driving the touch panel to vibrate.

Other aspects may be comprehended upon reading and understanding drawings and detailed description

### BRIEF DESCRIPTION OF DRAWINGS

Accompanying drawings are used for providing further understanding of technical solutions of the present disclosure, constitute a portion of the specification, and are used for explaining the technical solutions of the present disclosure together with embodiments of the present disclosure, but do not constitute limitations on the technical solutions of the present disclosure. Shapes and sizes of various components in the drawings do not reflect actual scales, but are only intended to schematically illustrate contents of the present disclosure.

FIG. 1 is a schematic diagram of a structure of a haptic feedback apparatus according to an exemplary embodiment of the present disclosure.

FIGS. 2A to 2C show schematic diagrams of a modulation method of an excitation signal according to an embodiment of the present disclosure.

FIGS. 3A to 3C are schematic diagrams of structures of three other haptic feedback apparatuses according to an exemplary embodiment of the present disclosure.

FIG. 4A is a schematic diagram of a waveform of a first drive signal according to an exemplary embodiment of the present disclosure.

FIG. 4B is a schematic diagram of a waveform of a second drive signal according to an exemplary embodiment of the present disclosure.

FIG. 5A is a schematic diagram of patterns of several virtual function according to an exemplary embodiment of the present disclosure.

FIG. 5B is a schematic diagram of a frequency doubling circuit according to an exemplary embodiment of the present disclosure.

FIGS. 6A to 6C are schematic diagrams of three application scenarios according to an exemplary embodiment of the present disclosure.

FIG. 7 is a schematic flow diagram of a haptic feedback method according to an exemplary embodiment of the present disclosure.

### DETAILED DESCRIPTION

To make objectives, technical solutions, and advantages of the present disclosure clearer, the embodiments of the present disclosure will be described in detail below with reference to the accompanying drawings. It is to be noted that the embodiments and features in the embodiments of the present disclosure may be randomly combined with each other if there is no conflict.

Unless otherwise defined, technical terms or scientific terms used in the embodiments of the present disclosure should have usual meanings understood by those of ordinary skills in the art to which the present disclosure belongs. “First”, “second”, and similar terms used in the embodiments of the present disclosure do not represent any order, quantity, or importance, but are only used for distinguishing different components. “Include”, “contain”, or a similar word means that an element or article appearing before the word covers an element or article and equivalent thereof listed after the word, and other elements or articles are not excluded.

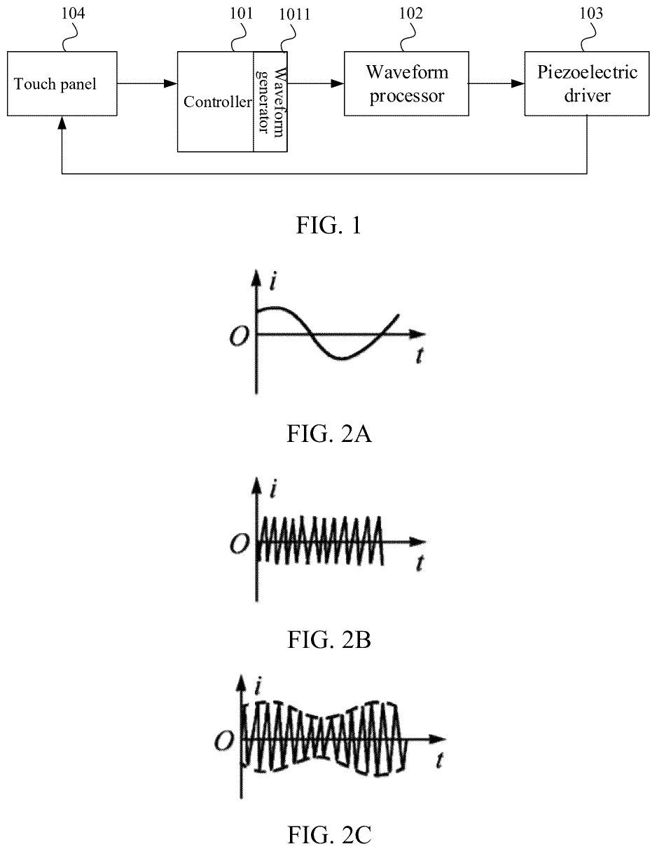

As shown in FIG. 1, an embodiment of the present disclosure provides a haptic feedback apparatus including a controller 101, a waveform processor 102, a piezoelectric driver 103, and a touch panel 104, and the haptic feedback apparatus further includes a virtual function region (not shown in the figure), wherein the controller 101 includes a waveform generator 1011;
a touch panel 104 is configured to detect touch position information of a user interaction and output the touch position information to the controller 101;
the controller 101 is configured to determine whether the touch position information is in the virtual function region, and if the touch position information is in the virtual function region, the controller 101 controls the waveform generator 1011 to generate an excitation signal and output it to the waveform processor 102;
a waveform processor 102 is configured to amplify the excitation signal and output the processed signal to the piezoelectric driver 103; and
the piezoelectric driver 103 is configured to receive the processed signal and generate deformation, thereby driving the touch panel 104 to vibrate.

In the haptic feedback apparatus according to an embodiment of the present disclosure, the controller 101 controls the waveform generator 1011 to generate an excitation signal and outputs the excitation signal to the waveform processor 102, the waveform processor 102 amplifies the excitation signal and outputs the processed signal to the piezoelectric driver 103, and the piezoelectric driver 103 receives the processed signal and generates deformation, thereby driving the touch panel 104 to vibrate, which may provide a variety of haptic feedbacks for users, and may enhance operation safety and effectiveness, enrich user experience, and meet the needs of different users.

In some exemplary implementations, the controller 101 may include a development board or a computer motherboard, and operating systems such as Windows, Android, and Linux are installed on the controller 101. The controller may include: a central processing unit (including, but not limited to, Intel CPU, AMD processor, and different series of processors from different manufacturers based on ARM core), running memory, storage units (such as disc hard disk, SSD hard disk, flash memory, etc.), display driver card, wired/wireless network adapter, waveform generator, etc.

In some exemplary implementations, the waveform generator 1011 may include an audio chip configured to output an excitation signal, which may be an envelope-modulated carrier signal.

In some exemplary implementations, the excitation signal may be generated by the controller 101 controlling the audio chip to play an audio file.

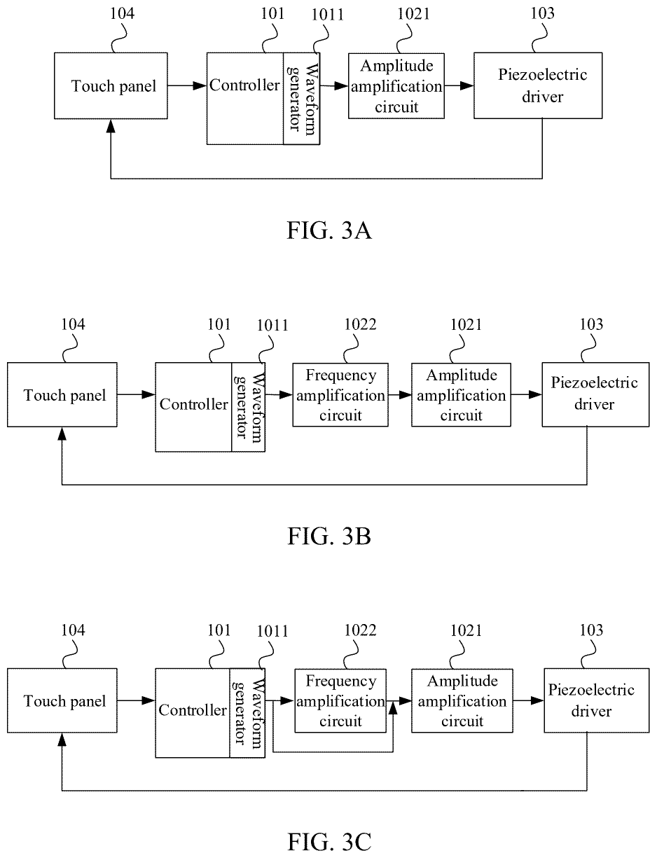

As shown in FIGS. 2A to 2C, the signal shown in FIG. 2A is a modulated signal, the signal shown in FIG. 2B is a carrier signal, and the signal shown in FIG. 2C is an envelope-modulated carrier signal, also called an amplitude modulated wave signal (causing the amplitude of the carrier signal (modulated signal) to change according to the modulated signal). The carrier signal modulated by envelope maintains the frequency characteristics of high-frequency carrier, but the shape of the envelope is similar to the waveform of the modulated signal, and its amplitude is determined by the strength of the modulated signal.

In an embodiment of the present disclosure, a frequency of the carrier signal is set according to a resonance frequency of the piezoelectric driver 103 and the touch panel 104, and a frequency of the carrier signal may be equal to or close to the resonance frequency of the piezoelectric driver 103 and the touch panel 104, or may not operate in the vicinity of the resonance frequency of the piezoelectric driver 103 and the touch panel 104. For example, when the user selects a sound requiring a strong tactile sensation and a loud vibration, the frequency of the carrier signal may be set to or in the vicinity of the resonance frequency point between the piezoelectric driver 103 and the touch panel 104; and the frequency of the carrier signal may be set to a frequency relatively away from the resonant frequency point when the user selects that a lower tactile sensation and a lower vibration sound are required.

In an embodiment of the present disclosure, the shape, frequency, and amplitude of the modulated signal are selected according to the characteristics of the human-computer interaction event, and for example, when the amplitude of the modulated signal is larger, the tactile sensation is more obvious; and the higher the frequency of the modulated signal, the denser the vibration tactile sensation, the shorter the effect, and the steep shape of the modulated signal (for example, the square wave or triangular wave is straighter than the sine wave), the higher the tactile sensation discrimination.

In other exemplary implementations, the waveform generator may also be generated by a single chip microcomputer, a Field Programmable Gate Array (FPGA), an Application Specific Integrated Circuit (ASIC), or the like, and the embodiments of the present disclosure are not limited thereto.

In some exemplary implementations, the excitation signal generated by the waveform generator 1011 may include a first excitation signal and/or a second excitation signal, and a wavelength of the excitation signal generated by the waveform generator 1011 is within an audio band. An embodiment of the present disclosure generates an audible reminder through an excitation signal generated by the waveform generator 1011.

Signal is a tool for carrying messages and a carrier of messages. Broadly speaking, it includes optical signals, acoustic signals and electrical signals and the like. Acoustic signals are generated by the vibration of sound-producing bodies. They require a medium for propagation, and may propagate in solids, liquids and gases, but cannot propagate in vacuum. The frequency range of sound waves that people may hear id from 20 Hz to 20000 Hz. Sound waves lower than 20 Hz are infrasound waves, and sound waves higher than 20000 Hz are ultrasonic waves. The waveform generator 1011 may generate a first excitation signal and/or a second excitation signal according to the type of haptic feedback required by the user, and when the user needs vibration haptic feedback (and/or audible feedback), the waveform generator 1011 generates the first excitation signal; when the user requires surface haptic feedback, the waveform generator 1011 generates a second excitation signal; and when the user requires vibrational haptic feedback and surface haptic feedback (and/or audible feedback), the waveform generator 1011 generates a first excitation signal and a second excitation signal in time.

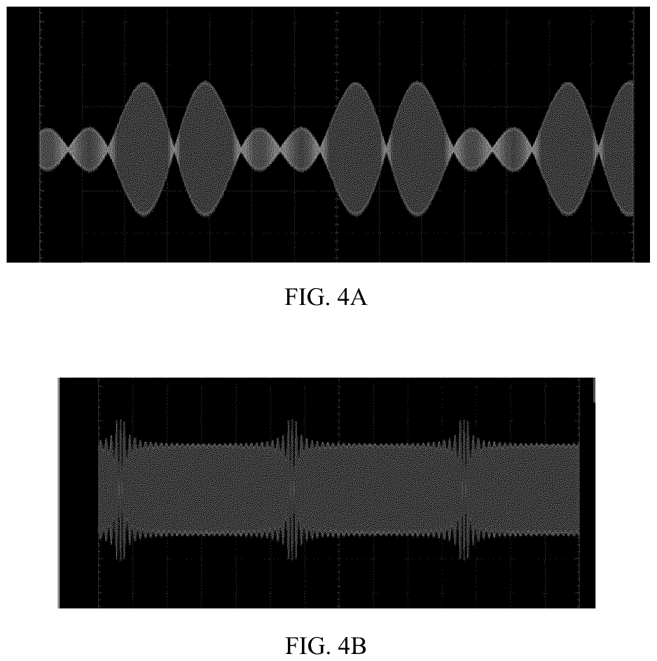

In some exemplary implementations, as shown in FIGS. 3A-3C, the waveform processor 102 includes: an amplitude amplification circuit 1021; the amplitude amplification circuit 1021 is provided between the waveform generator 1011 and the piezoelectric driver 103, and is configured to output a drive signal after amplifying the amplitude of the first excitation signal (here, the first excitation signal may be the first excitation signal generated by the waveform generator 1011 and/or the first excitation signal output by the frequency amplification circuit 1022), and output the drive signal to the piezoelectric driver 103.

In some exemplary implementations, the drive signal includes a first drive signal, which is output by the amplitude amplification circuit 1021 after amplifying the amplitude of the first excitation signal generated by the waveform generator 1011.

In an embodiment of the present disclosure, both the first excitation signal and the first drive signal generated by the waveform generator 1011 may be sound band signals, and a frequency of the first excitation signal generated by the waveform generator 1011 and a frequency of the first drive signal may be the same. The first excitation signal generated by the waveform generator 1011 is used to generate an audible reminder, and the first drive signal is used to excite the piezoelectric driver 103 to generate a vibration haptic reminder.

In an embodiment of the present disclosure, the first drive signal is a voltage signal, and compared with the first excitation signal generated by the waveform generator 1011, the first drive signal is only amplified in amplitude, for example, from 3V to 100V, and the frequency is lower, so the first drive signal is used to generate haptic feedback of inertial vibration.

In some exemplary implementations, the frequency of the first excitation signal and the frequency of the first drive signal generated by the waveform generator 1011 are between 50 Hz and 500 Hz.

In some exemplary implementations, the amplitude of the first drive signal is amplified by 2 to 30 times compared to the amplitude of the first excitation signal generated by the waveform generator 1011.

In some exemplary implementations, as shown in FIG. 3A, the waveform processor 102 may include an amplitude amplification circuit 1021, the excitation signal generated by the waveform generator 1011 may include a first excitation signal, and the amplitude amplification circuit 1021 is configured to amplify the amplitude of the first excitation signal generated by the waveform generator 1011 to obtain a first drive signal and output the first drive signal to the piezoelectric driver 103. In the present embodiment, the first excitation signal generated by the waveform generator 1011 is used to generate an audible reminder, and the first drive signal is used to excite the piezoelectric driver 103 to generate a vibration haptic reminder.

In an embodiment of the present disclosure, in the haptic feedback apparatus shown in FIG. 3A, the waveform generator 1011 generates a first excitation signal, and the amplitude amplification circuit 1021 amplifies the amplitude of the first excitation signal generated by the waveform generator 1011, outputs a first drive signal, and outputs the first drive signal to the piezoelectric driver 103.

In some exemplary implementations, as shown in FIG. 3B or FIG. 3C, the waveform processor 102 may further include: a frequency amplification circuit 1022; and the frequency amplification circuit 1022 connects the waveform generator 1011 and the amplitude amplification circuit 1021, and the frequency amplification circuit 1022 is configured to output a first excitation signal after amplifying a frequency of the second excitation signal generated by the waveform generator 1011 and output the first excitation signal to the amplitude amplification circuit 1021.

In some exemplary implementations, as shown in FIG. 3B, the waveform processor 102 may include a frequency amplification circuit 1022 and an amplitude amplification circuit 1021, and the excitation signal generated by the waveform generator 1011 may include a second excitation signal, wherein the frequency amplification circuit 1022 is configured to amplify a frequency of the second excitation signal generated by the waveform generator 1011 to obtain a first excitation signal and output the first excitation signal to the amplitude amplification circuit 1021; and the amplitude amplification circuit 1021 is configured to amplify an amplitude of the first excitation signal output from the frequency amplification circuit 1022 to obtain a second drive signal, and output the second drive signal to the piezoelectric driver 103.

In the present embodiment, the drive signal includes a second drive signal, which is output by the amplitude amplification circuit 1021 after amplifying the amplitude of the first excitation signal output by the frequency amplification circuit 1022.

In some exemplary implementations, the frequency of the first excitation signal output by the frequency amplification circuit 1022 is m times the frequency of the second excitation signal, wherein m is any value from 2 to 10.

In the present embodiment, the second drive signal is an ultrasonic band signal, and the frequency of the second drive signal is the same as the frequency of the first excitation signal output by the frequency amplification circuit 1022, that is, the first excitation signal output by the frequency amplification circuit 1022 is also an ultrasonic band signal. The second drive signal is used to excite the piezoelectric driver to generate a surface haptic reminder.

In some exemplary implementations, the amplitude of the second drive signal is n times the amplitude of the first excitation signal output by the frequency amplification circuit 1022, wherein n is any value from 2 to 30, and the second drive signal is used to excite the piezoelectric driver 103 to generate a surface haptic reminder.

In some exemplary implementations, the frequency of the first excitation signal and the frequency of the second drive signal output by the frequency amplification circuit 1022 are greater than 20 kHz.

In the haptic feedback apparatus shown in FIG. 3B, the waveform generator 1011 generates a second excitation signal, and the frequency amplification circuit 1022 outputs the first excitation signal (the first excitation signal output by the frequency amplification circuit 1022 may be referred to as an intermediate processing signal, it is noted that a waveform of the first excitation signal output by the frequency amplification circuit 1022 is different from a waveform of the first excitation signal generated by the waveform generator 1011, the first excitation signal output by the frequency amplification circuit 1022 is an ultrasonic band signal, and the first excitation signal generated by the waveform generator 1011 is an acoustic band signal) after amplifying a frequency of the second excitation signal generated by the waveform generator 1011, and the amplitude amplification circuit 1021 outputs a second drive signal after amplifying the amplitude of the first excitation signal output by the frequency amplification circuit 1022, and outputs the second drive signal to the piezoelectric driver 103.

In some exemplary implementations, as shown in FIG. 3C, the waveform processor 102 may include a frequency amplification circuit 1022 and an amplitude amplification circuit 1021, and the excitation signal generated by the waveform generator 1011 may include a first excitation signal and a second excitation signal.

The controller 101 controls the waveform generator 1011 to generate an excitation signal, including: controlling the waveform generator 1011 to generate a first excitation signal during a first period, and controlling the waveform generator 1011 to generate a second excitation signal during a second period;
the amplitude amplification circuit 1021 is configured to amplify the amplitude of the first excitation signal generated by the waveform generator 1011 during a first period to obtain a first drive signal and output the first drive signal to the piezoelectric driver 103;
the frequency amplification circuit 1022 is configured to amplify the frequency of the second excitation signal generated by the waveform generator 1011 during a second period to obtain a first excitation signal and output the first excitation signal to the amplitude amplification circuit 1021 (the first excitation signal output by the frequency amplification circuit 1022 may be referred to as an intermediate processing signal, and it is noted that a waveform of the first excitation signal output by the frequency amplification circuit 1022 is different from a waveform of the first excitation signal generated by the waveform generator, the first excitation signal output by the frequency amplification circuit 1022 is an ultrasonic band signal, and the first excitation signal generated by the waveform generator 1011 is an acoustic band signal); and
the amplitude amplification circuit 1021 is further configured to amplify the amplitude of the first excitation signal output by the frequency amplification circuit 1022 during a second period to obtain a second drive signal and output the second drive signal to the piezoelectric driver 103, and the first period and the second period do not intersect.

In the haptic feedback apparatus shown in FIG. 3C, the waveform generator 1011 generates a first excitation signal and a second excitation signal at different times, and the amplitude amplification circuit 1021 outputs a first drive signal after amplifying the amplitude of the first excitation signal generated by the waveform generator 1011, and outputs the first drive signal to the piezoelectric driver 103; and the frequency amplification circuit 1022 outputs the first excitation signal (the first excitation signal output by the frequency amplification circuit 1022 may be referred to as an intermediate processing signal, it is noted that a waveform of the first excitation signal output by the frequency amplification circuit 1022 is different from a waveform of the first excitation signal generated by the waveform generator 1011, the first excitation signal output by the frequency amplification circuit 1022 is an ultrasonic band signal, and the first excitation signal generated by the waveform generator 1011 is an acoustic band signal) after amplifying a frequency of the second excitation signal generated by the waveform generator 1011, and the amplitude amplification circuit 1021 outputs a second drive signal after amplifying the amplitude of the first excitation signal output by the frequency amplification circuit 1022, and outputs the second drive signal to the piezoelectric driver 103.

In some exemplary implementations, the frequency of the second excitation signal generated by the waveform generator 1011 may be greater than the frequency of the first excitation signal generated by the waveform generator 1011.

In some exemplary implementations, the controller 101 controls the waveform generator 1011 to generate the excitation signal, including:
controlling the waveform generator 1011 to generate a first excitation signal by the controller 101 during a first period,
and controlling the waveform generator 1011 to generate the second excitation signal by the controller 101 during a second period, wherein the first period and the second period do not intersect.

In the present embodiment, during the first period, the waveform processor 102 is used to amplify the amplitude of the first excitation signal generated by the waveform generator 1011 to generate a first drive signal, and the piezoelectric driver 103 is excited by the first drive signal to generate a low-frequency vibration reminder; and during the second period, the waveform processor 102 used to amplify both the frequency and the amplitude of the second excitation signal generated by the waveform generator 1011 to generate a second drive signal, and the piezoelectric driver 103 is excited by the second drive signal to generate a surface haptic reminder. Since the excitation signal of the ultrasonic band acts on the piezoelectric driver 103 to produce a film pressing effect, thereby changing the surface friction coefficient, and generating a virtual surface haptic feedback effect similar to texture, stuck, etc. through waveform modulation, and by setting the frequency of the second excitation signal to be large, it is easy for the waveform processor 102 to quickly set the frequency of the second excitation signal to the required ultrasonic band range.

In some exemplary implementations, the first period and the second period may be cycled a plurality of times, however, embodiments of the present disclosure are not limited thereto. For example, assuming that the number of cycles is 2 times, the first period includes a period from 0 to t1 and a period from t2 to t3, and the second period includes a period from t1 to t2 and a period from t3 to t4, and 0<t1<t2<t3<t4.

In other exemplary embodiments, the excitation signal generated by the waveform generator 1011 may include only the first excitation signal, and at this time, the waveform processor 102 is used to amplify the amplitude of the first excitation signal generated by the waveform generator 1011 to generate a first drive signal, and the piezoelectric driver 103 is excited by the first drive signal to generate a low-frequency vibration reminder; or the excitation signal generated by the waveform generator 1011 may include only the second excitation signal, and at this time, the waveform processor 102 is used to amplify both the frequency and the amplitude of the second excitation signal generated by the waveform generator 1011 to generate a second drive signal, and the piezoelectric driver 103 is excited by the second drive signal to generate a surface haptic reminder.

In an embodiment of the present disclosure, the second drive signal is a drive signal obtained by amplifying both of the frequency and the amplitude of the second excitation signal generated by the waveform generator 1011, the frequency of the second drive signal is more than 20 kHz, and the second drive signal belongs to the signal of the ultrasonic band, has a high frequency and is used to generate a surface haptic effect of friction texture on the surface.

In the present embodiment, the wavelengths of the first excitation signal and the first drive signal generated by the waveform generator 1011 are both within the audio band, and the frequency of the first excitation signal generated by the waveform generator 1011 is the same as the frequency of the first drive signal. The first excitation signal generated by the waveform generator 1011 is used to generate an audible reminder, and the first drive signal is used to excite the piezoelectric driver to generate a vibration haptic reminder.

In some exemplary implementations, the second drive signal is an ultrasonic band signal, and the frequency of the first excitation signal output by the frequency amplification circuit 1022 is m times the frequency of the second excitation signal, wherein m is any value from 2 to 10.

In some exemplary implementations, the amplitude of the second drive signal is n times the amplitude of the first excitation signal output by the frequency amplification circuit 1022, wherein n is any value from 2 to 30.

In some exemplary implementations, the frequency of the second excitation signal is between 2 kHz and 15 kHz.

In some exemplary implementations, the frequency of the first excitation signal output by the frequency amplification circuit 1022 and the frequency of the second drive signal are the same, and the frequency of the first excitation signal and the frequency of the second drive signal output by the frequency amplification circuit 1022 are greater than or equal to 20 kHz.

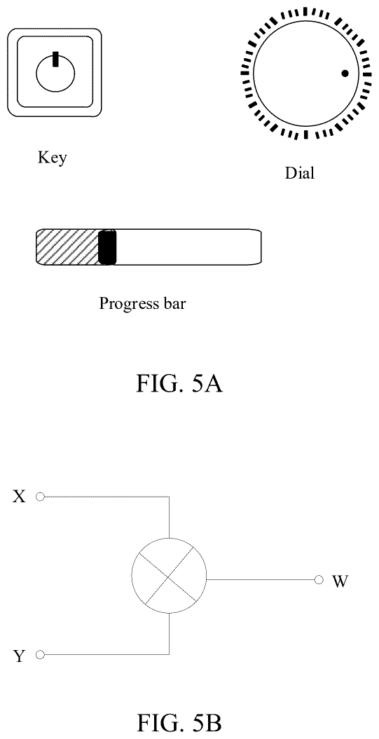

In an embodiment of the present disclosure, the first drive signal acts on the piezoelectric driver 103 to generate a vibration haptic reminder, and an exemplary first drive signal is shown in FIG. 4A. In some exemplary implementations, since the first drive signal is a signal obtained by amplifying the amplitude of the first excitation signal generated by the waveform generator 1011, the frequency of the first drive signal is the same as the frequency of the first excitation signal generated by the waveform generator 1011. As the frequency of the first drive signal increases, the number of waveform cycles in which the tactile sensation is generated also increases. Different frequencies and the number of different cycles mainly affect the type of tactile sensation, while different drive voltages mainly affect the intensity of tactile sensation.

In an embodiment of the present disclosure, the second drive signal acts on the piezoelectric driver 103 to generate a surface haptic reminder, and an exemplary second drive signal is shown in FIG. 4B. In some exemplary implementations, the frequency of the second drive signal is selected according to the resonance frequencies of the piezoelectric driver 103 and the touch panel 104, different frequencies of the second drive signal correspond to different types of surface tactile sensation, and when the user selects to require a strong surface tactile sensation, the frequency of the second drive signal may be set in the vicinity of resonance frequency point of the piezoelectric driver 103 and the touch panel 104; and when the user selects to require a lower surface tactile sensation, the frequency of the second drive signal may be set to a frequency relatively away from the resonant frequency point.

For example, the frequency of the second drive signal may be set between 20 kHz and 100 kHz in consideration of drive circuit cost and power consumption.

In an embodiment of the present disclosure, in fact, the piezoelectric driver 103 drives the touch panel 104 to vibrate whether it is the first drive signal (sound band signal) or the second drive signal (ultrasonic band signal). It's just that the vibration generated by the ultrasonic signal will produce the film pressing effect, change the surface friction coefficient, and generate the surface haptic feedback effect, while the vibration generated by the sound band signal generates low-frequency vibration haptic feedback effect (i.e. vibration haptic feedback).

Compared with ERM and LRA, the piezoelectric driver 103 has a fast response time and a wide frequency band, which is more suitable for the needs of virtual tactile sensation. An embodiment of the present disclosure uses the piezoelectric driver 103 to generate an audible reminder through the action of an acoustic excitation signal during human-computer interaction (for example, the audible reminder may be a ta-da-da or a buzzing sound effect); a low-frequency vibration signal is used to generate a vibration haptic feedback effect (for example, the vibration haptic feedback effect may be a knock feeling of pressing a key, an impact feeling of collision of an object, etc.); the action of the excitation signal of the ultrasonic band generates a film pressing effect, thus changing the surface friction coefficient, and a virtual surface haptic feedback effect similar to texture, stuck, etc. is generated through waveform modulation (for example, the virtual surface haptic feedback effect may be textures with different densities, a gradient sense of the progress bar and a stuck sense of the knob, etc.).

In some exemplary implementations, the touch panel 104 may include a panel substrate material and an electrode array composed of a plurality of touch drive electrodes and a plurality of touch sensing electrodes disposed on the panel substrate material, the touch panel 104 may be divided into n touch regions, and n is an integer greater than or equal to 2; each touch region includes at least one touch drive electrode and at least one touch sensing electrode, and a plurality of touch drive electrodes and a plurality of touch sensing electrodes are arranged in order to be able to individually provide touch scan signals to the touch drive electrodes within each touch region during a touch scan and be able to individually receive a sensing signal caused by a touch action on the touch panel 104 from touch sensing electrodes within each touch region to determine a touch position information of the touch action on the touch panel 104.

In some exemplary implementations, the touch panel 104 may include an optical sensor configured to detect touch position information and/or touch action of a user interaction and output the detected touch position information and/or touch action to the controller 101. For example, the touch action may include a click, a double click, a swipe, and the like.

In some exemplary implementations, the touch panel 104 may include a pressure sensor configured to detect pressing force information when the touch panel 104 is touched, and output the detected pressing force information to the controller 101.

In some exemplary implementations, the controller 101 is further configured to, according to at least one of the following: pressing force information, tactile sensation strength information selected by the user, and/or a touch action, select a corresponding excitation signal, a frequency amplification factor, and an amplitude amplification factor.

For example, in an embodiment of the present disclosure, the controller 101 may select an excitation signal with a corresponding amplitude according to a magnitude of the pressing force detected by the pressure sensor. For example, assuming that a user's finger touches a virtual button in a virtual function region, when the user taps the virtual button and the pressing force value detected by the pressure sensor is small, at this time, the controller 101 may control the waveform generator 1011 to generate an excitation signal with a small amplitude; when the user lightly presses the key and the pressing force value detected by the pressure sensor is moderate, at this time, the controller 101 may control the waveform generator 1011 to generate an excitation signal with a moderate amplitude; and when the user presses the key again and the pressing force value detected by the pressure sensor is large, and at this time, the controller 101 may control the waveform generator 1011 to generate an excitation signal with a large amplitude.

For example, in an embodiment of the present disclosure, the controller 101 may select an excitation signal of a corresponding amplitude and/or an amplitude amplification factor according to the tactile sensation strength selected by the user. For example, when the user selects to require a stronger tactile sensation, the controller 101 may control the waveform generator 1011 to generate an excitation signal with a larger amplitude, and/or control the waveform processor 102 to select a larger amplitude amplification factor to amplify the excitation signal so that the amplitude of the generated first drive signal and/or the second drive signal meets the excitation signal amplitude requirement required for generating a stronger tactile sensation.

For example, in an embodiment of the present disclosure, the controller 101 may select an excitation signal of a corresponding frequency and/or a frequency amplification factor according to a tactile sensation strength selected by the user. For example, when the user selects to require a strong tactile sensation, the controller 101 may control the waveform generator 1011 to generate an excitation signal whose frequency of the carrier signal is close to the resonant frequency point, and/or control the waveform processor 102 to select a frequency amplification factor that may allow a frequency of the second drive signal after amplifying the frequency to be close to the resonant frequency point to amplify the excitation signal.

For example, in an embodiment of the present disclosure, the haptic feedback apparatus may pre-store tactile sensation types corresponding to different tactile sensation actions and signal frequencies and the numbers of cycles corresponding to different tactile sensation types. When the touch action of the user is detected, the controller 101 may select a corresponding excitation signal and/or frequency amplification factor according to the signal frequency and the number of cycles corresponding to the detected touch action.

In actual use, different excitation signals and frequency amplification factors, and tactile sensation types, tactile sensation intensities and the like corresponding to amplitude amplification factors may be obtained by simulation, and the obtained information is stored in the haptic feedback apparatus; and the user may select the excitation signals, frequency amplification factors and amplitude amplification factors corresponding to each tactile sensation action and tactile sensation intensities according to his own preferences.

In some exemplary implementations, the haptic feedback apparatus may include a base substrate, a display panel disposed on the base substrate, a touch panel 104 disposed on a side of the display panel away from the base substrate, and a cover plate disposed on a side of the touch panel 104 away from the display panel.

In other exemplary embodiments, the haptic feedback apparatus may include a base substrate, a touch panel 104 disposed on the base substrate, and a cover plate disposed on a side of the touch panel 104 away from the base substrate. In an embodiment of the present disclosure, the haptic feedback apparatus may or may not be provided with a display panel, and an embodiment of the present disclosure is not limited thereto.

In some exemplary implementations, the piezoelectric driver 103 is disposed on a cover plate. For example, the piezoelectric driver 103 may be provided at an edge position of the cover plate. For example, the piezoelectric driver 103 may be provided on a side of the cover plate close to the base substrate or on a side of the cover plate away from the base substrate.

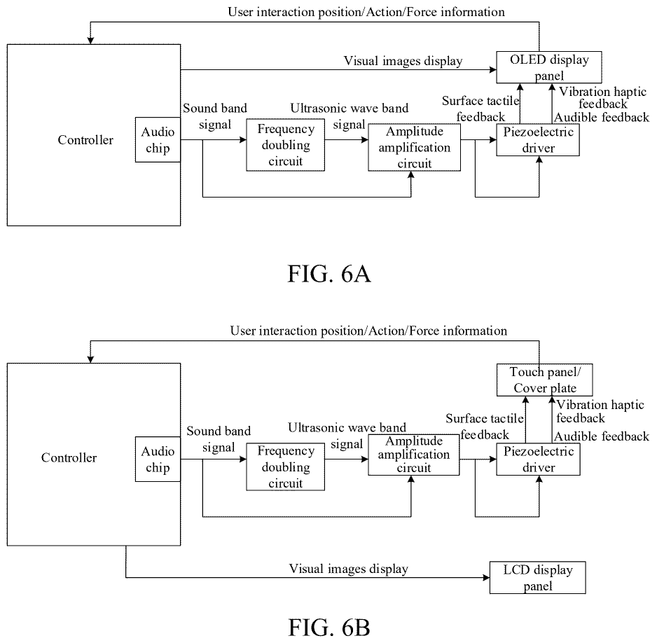

In some exemplary implementations, the virtual function region may be a virtual function pattern region provided on the cover plate, the virtual function pattern region is provided with one or more virtual function patterns, and the virtual function pattern may include at least one of the following patterns: a key, a progress bar, and a dial, as shown in FIG. 5A.

For example, the virtual function pattern may be printed on the cover plate through a patterning process (various patterning processes such as screen printing, spray painting, adhesive patch, etc.), or the virtual function pattern may be projected on a target position of the cover plate, and an embodiments of the present disclosure are not limited thereto.

In some exemplary implementations, the haptic feedback apparatus further includes a display module including a display panel that may display a human-computer interaction interface containing a virtual function region.

In some exemplary implementations, the cover plate may be a relatively hard material such as glass, metal, or plastic provided separately, or may be a panel substrate material in a touch panel, and an embodiment of the present disclosure does not limit thereto.

In some exemplary implementations, the display panel may be an Organic Light-Emitting Diode (OLED) display panel, a Liquid Crystal Display (LCD) panel, or the like, and an embodiment of the present disclosure are not limited thereto.

In an embodiment of the present disclosure, the amplitude amplification circuit 1021 may be implemented using an existing signal amplification circuit, and exemplarily, the amplitude amplification circuit 1021 may be a triode amplification circuit. Since the signal amplitude of the excitation signal generated by the waveform generator 1011 is small, by amplifying the amplitude of the signal by the amplitude amplification circuit 1021, the piezoelectric driver may be excited to generate vibration with a large amplitude, and vibration haptic feedback and/or surface haptic feedback may be generated.

In some exemplary implementations, the frequency amplification circuit 1022 may include a frequency doubling circuit.

In some exemplary implementations, as shown in FIG. 5B, the frequency doubling circuit may include a multiplier circuit. Exemplary, X=Y=A_{c} sin(ωt). The output signal

$$W = - \frac{1}{2} {A}_{c} [ cos ( 2 ω t ) - 1 ] ,$$

the frequency becomes twice that of the original input signal. In actual use, the frequency doubling circuit may set a plurality of multiplier circuits to be cascaded according to needs, so that the frequency of the intermediate processing signal is amplified to a required multiple value.

In some exemplary implementations, the frequency amplification factor of the frequency doubling circuit may be between 2 times and 10 times, and however, an embodiment of the present disclosure is not limited thereto.

In some exemplary implementations, the amplitude amplification factor of the amplitude amplification circuit 1021 may be between 2 times and 30 times, and however, an embodiment of the present disclosure is not limited thereto.

An embodiment of the present disclosure provides a haptic feedback apparatus, which includes a controller 101, a waveform processor 102, a piezoelectric driver 103, and a touch panel 104. The controller 101 includes an audio chip, and the controller 101 (for example, the controller may be the main control board) controls the audio chip to output an excitation signal to the waveform processor 102. The waveform processor 102 amplifies the excitation signal and outputs the excitation signal to the piezoelectric driver 103, to excite the piezoelectric driver 103 to drive the touch panel 104 to vibrate, generating a haptic feedback effect and an audible effect. In an embodiment of the present disclosure, the haptic feedback effect may include a vibration haptic feedback and/or a surface haptic feedback effect. The haptic feedback apparatus provided by an embodiment of the present disclosure achieves a low-cost and simple-structure drive solution that satisfies multiple interactive functional experiences of audible feedback, vibration haptic feedback, and surface haptic feedback.

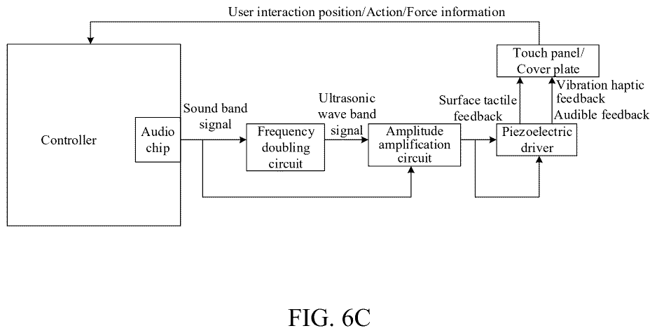

FIG. 6A is a schematic diagram of an operation of the haptic feedback apparatus of the present disclosure applied to an OLED display panel, wherein a piezoelectric driver is attached to a back surface of the OLED display panel. Hereinafter, a technical solution of the present disclosure will be described with reference to FIG. 6A.

The central processing unit (i.e. controller) on the main control board controls the display of human-computer interaction interface on the OLED display panel through the display driver card. When the operator interacts with the human-computer interaction interface, the user's finger interaction position, action, pressing force and other information are detected through the touch panel and sensors (such as pressure sensors, optical sensors, etc.) arranged on the touch panel and fed back to the central processor, and the central processor controls the man-machine interaction interface to switch according to the interaction information.

At the same time, the central processor controls the audio chip to generate an excitation signal of a sound band (20-20 kHz). In a period of time, the excitation signal is directly amplified by an amplitude amplification circuit and converted into a first drive signal, and the first drive signal excites the piezoelectric driver to drive the OLED display panel to vibrate, generate audible feedback (da da da or buzzing sound effect) and vibration haptic feedback (knocking feeling of key pressing, impact feeling of object collision, etc.). In another period, after the excitation signal is processed by the frequency doubling circuit, the frequency is converted into the original multiple times (such as 2 times) to obtain the intermediate processing signal of the ultrasonic band (>20 kHz). The second drive signal acts on the piezoelectric driver to drive the OLED display panel to generate a ultrasonic band vibration, producing a film pressing effect and changing the surface friction coefficient during human-computer interaction. By modulating the excitation signal differently, textures with different densities, a gradual change feeling of the progress bar, and a stuck feeling of the knob may be generated.

In FIG. 6A, the main control board may be a development board or a computer motherboard equipped with different operating systems such as Windows, Android, and Linux; and the main control board has a central processing unit (including but not limited to Intel CPU, AMD processor, and different series of processors from different manufacturers based on ARM core), running memory, storage units (such as disk hard disk, SSD hard disk, flash memory, etc.), display driver card, wired/wireless network adapter and audio chip, etc.

The excitation signal can be generated by the main control board controlling the audio chip to play audio files. The audio files can be in different formats such as way (waveform sound file), wmv (Windows Media Video), mp3 (a player), etc., and may be programmed through various software such as Audacity (a kind of audio processing software) or Matlab (a commercial mathematics software). The excitation signal is typically an envelope-modulated carrier signal. The frequency of the carrier signal depends on the resonance frequencies of the piezoelectric driver and the OLED display panel, and the frequency of the carrier signal may be equal to or close to the resonance frequencies of the piezoelectric driver and the OLED display panel, or may not operate in the vicinity of the resonance frequency of the piezoelectric driver and the OLED display panel. The shape, frequency and amplitude of envelope modulation correspond to the characteristics of human-computer interaction events. For example, the larger the amplitude, the more obvious the tactile sensation; and if the frequency is high, the vibration tactile sensation will be denser and the effect will be shorter. If the envelope shape is steep, the tactile sensation discrimination is higher.

The frequency doubling circuit may be implemented by a multiplier circuit. The frequency doubling circuit and the amplitude amplification circuit may be separated or designed and manufactured on the same circuit board.

FIG. 6B is a schematic diagram of an operation of the haptic feedback apparatus of the present disclosure applied to an LCD display panel, wherein the piezoelectric driver may be attached to a back surface of a cover plate or a touch panel, and the piezoelectric driver and the touch panel/cover plate form a vibration complex. Hereinafter, a technical solution of the present disclosure will be described with reference to FIG. 6B.

The central processing unit on the main control board controls the LCD display panel below the vibration complex to display the human-computer interaction interface through the display drive card. When the operator interacts on the surface of the human-computer interaction interface, the central processor controls the switching of the human-computer interaction interface on the LCD display panel according to the needs through the display drive card. When the operator interacts with the human-computer interaction interface, the user's finger interaction position, action, pressing force and other information are detected through the touch panel and sensors (such as pressure sensors, optical sensors, etc.) arranged on the touch panel and fed back to the central processor, and the human-computer interaction interface will be switched according to the interaction information.

At the same time, the central processor controls the audio chip to generate an excitation signal of a sound band (20-20 kHz). In a period of time, the excitation signal is directly amplified by a frequency amplification circuit and converted into a first drive signal, and the first drive signal excites the piezoelectric driver to drive the touch panel/the cover plate to vibrate, generate audible feedback (da da da or buzzing sound effect) and vibration haptic feedback (knocking feeling of key pressing, impact feeling of object collision, etc.). In another period, after the excitation signal is processed by the frequency doubling circuit, the frequency is converted into the original multiple times (such as 2 times) to obtain the intermediate processing signal of the ultrasonic band (>20 kHz). The second drive signal acts on the piezoelectric driver to drive the touch panel/the cover plate to generate a ultrasonic band vibration, producing a film pressing effect, changing the surface friction coefficient during human-computer interaction, and modulating the excitation signal differently, which may generate textures with different densities, a gradual change feeling of the progress bar, and a stuck feeling of the knob.

FIG. 6C is a schematic diagram of an operation of the haptic feedback apparatus of the present disclosure applied to a touch panel/a cover plate, wherein the piezoelectric driver may be attached to a back surface of a cover plate or a touch panel, and the piezoelectric driver and the touch panel/cover plate form a vibration complex. Hereinafter, a technical solution of the present disclosure will be described with reference to FIG. 6C.

For example, the piezoelectric driver is attached to a back of the cover plate, which may be made of various relatively hard materials such as glass, metal or plastic. The cover plate is printed (screen printing, spray painting, adhesive patch and other patterning processes) with patterns such as keys, progress bars, dials, etc. that respond to the diagram. When the operator interacts on the cover plate interface, the user's finger interaction position, action, pressing force and other information are detected through the touch panel and sensors (such as pressure sensors, optical sensors, etc.) arranged on the touch panel and fed back to the central processor, and the central processor controls the audio chip to play the audio file. When audible feedback or vibration haptic feedback is required, the first excitation signal generated by playing the audio file is amplified by the amplitude amplification circuit to obtain a first drive signal. The first drive signal excites the piezoelectric driver to drive the touch panel/cover plate to vibrate, thereby generating audible feedback and vibration haptic feedback. When the surface haptic feedback needs to be generated, the second excitation signal generated by playing the audio file is input to the frequency doubling circuit to modulate the carrier frequency of the second excitation signal into two or more times of the original, so as to become an intermediate processing signal of the ultrasonic band, and then amplified by the amplitude amplification circuit to obtain the second drive signal. The second drive signal excites the piezoelectric driver to drive the touch panel/cover plate complex to vibrate, thereby generating a film pressing effect, changing the surface friction coefficient during human-computer interaction, and generating a sense of texture density through waveform modulation, thereby achieving the effect of surface tactile feedback.

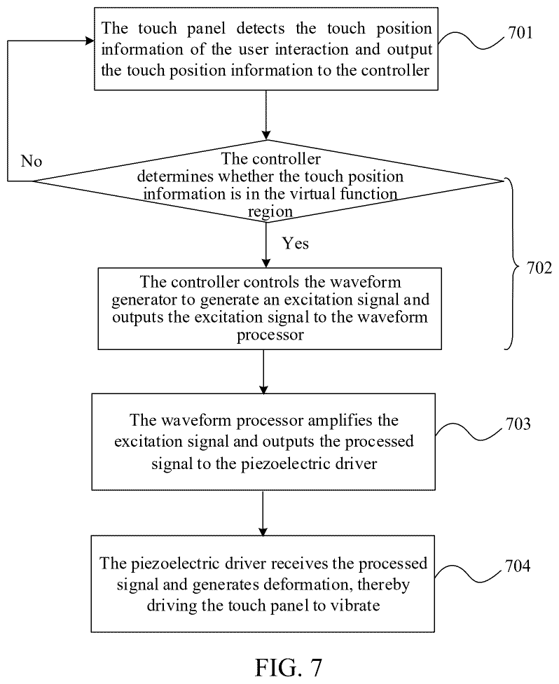

As shown in FIG. 7, an embodiment of the present disclosure also provides a haptic feedback method for a haptic feedback apparatus, wherein the haptic feedback apparatus includes a controller, a waveform processor, a piezoelectric driver, and a touch panel, the haptic feedback apparatus further includes a virtual function region, the controller includes a waveform generator, and the haptic feedback method includes following acts.

In act 701, the touch panel detects the touch position information of the user interaction and output the touch position information to the controller;
in act 702, the controller determines whether the touch position information is in the virtual function region, and if the touch position information is in the virtual function region, the controller controls the waveform generator to generate an excitation signal and outputs the excitation signal to the waveform processor;
in act 703, the waveform processor amplifies the excitation signal and outputs the processed signal to the piezoelectric driver; and
in act 704, the piezoelectric driver receives the processed signal and generates deformation, thereby driving the touch panel to vibrate.

In some exemplary implementations, the excitation signal generated by the waveform generator may include a first excitation signal and/or a second excitation signal, and a wavelength of the excitation signal generated by the waveform generator is within an audio band. An embodiment of the present disclosure generates an audible reminder through an excitation signal generated by the waveform generator.

In some exemplary implementations, the controller controls the waveform generator to generate the excitation signal, including:
controlling the waveform generator to generate a first excitation signal by the controller during a first period; and
controlling the waveform generator by the controller to generate a second excitation signal in a second period, wherein a frequency of the second excitation signal is greater than a frequency of the first excitation signal.

In some exemplary implementations, the processed signal may include a first drive signal and/or a second drive signal, wherein the first drive signal acts on the piezoelectric driver to generate a vibrational haptic reminder, and/or a second drive signal acts on the piezoelectric driver to generate a surface haptic reminder.

In some exemplary implementations, the waveform processor includes an amplitude amplification circuit, which is provided between the waveform generator and the piezoelectric driver; and a waveform processor amplifies the excitation signal and outputs the processed signal to the piezoelectric driver, including:
amplifying the amplitude of the first excitation signal by the amplitude amplification circuit to obtain a first drive signal and outputting the first drive signal to the piezoelectric driver.

In the present embodiment, the first excitation signal and the first drive signal generated by the waveform generator are both sound band signals, a frequency of the first excitation signal generated by the waveform generator is the same as a frequency of the first drive signal, the first excitation signal generated by the waveform generator is used to generate an audible reminder, and the first drive signal is used to excite the piezoelectric driver to generate a vibration haptic reminder.

In some exemplary implementations, the frequency of the first excitation signal and the frequency of the first drive signal generated by the waveform generator are both between 50 Hz and 500 Hz.

In some exemplary implementations, the waveform processor includes: a frequency amplification circuit and an amplitude amplification circuit, and the excitation signal generated by the waveform generator includes: a second excitation signal; and the waveform processor amplifies the excitation signal and outputs the processed signal to the piezoelectric driver, including:
amplifying the frequency of the second excitation signal by the frequency amplification circuit to obtain a first excitation signal and outputting the first excitation signal to an amplitude amplification circuit (the first excitation signal output by the frequency amplification circuit may be referred to as an intermediate processing signal, and it is noted that a waveform of the first excitation signal output by the frequency amplification circuit is different from a waveform of the first excitation signal generated by the waveform generator, the first excitation signal output by the frequency amplification circuit is an ultrasonic band signal, and the first excitation signal generated by the waveform generator is an acoustic band signal); and
amplifying the amplitude of the first excitation signal by the amplitude amplification circuit to obtain a second drive signal and outputting the second drive signal to the piezoelectric driver.

In some exemplary implementations, the second excitation signal is an acoustic band signal, the second drive signal is an ultrasonic band signal, and the frequency of the second drive signal is m times the frequency of the second excitation signal; wherein m is between 2 and 10, and the amplitude of the second drive signal is n times the amplitude of the second excitation signal; wherein n is between 2 and 30, the second drive signal is used to generate an audible reminder, and the second drive signal is used to excite the piezoelectric driver to generate a surface haptic reminder.

In some exemplary implementations, the frequency of the second excitation signal is between 2 kHz and 15 kHz, and the frequency of the second drive signal is greater than or equal to 20 kHz.

In some exemplary implementations, the waveform processor includes: a frequency amplification circuit and an amplitude amplification circuit, and the excitation signal generated by the waveform generator may include: a first excitation signal and a second excitation signal; and the waveform processor amplifies the excitation signal and outputs the processed signal to the piezoelectric driver, including:
amplifying the amplitude of the first excitation signal generated by the waveform generator by the amplitude amplification circuit in a first period to obtain a first drive signal and outputting the first drive signal to the piezoelectric driver,
amplifying the frequency of the second excitation signal generated by the waveform generator in the second period through the frequency amplification circuit to obtain a first excitation signal and outputting the first excitation signal to the amplitude amplification circuit (the first excitation signal output by the frequency amplification circuit may be referred to as an intermediate processing signal, and it is noted that a waveform of the first excitation signal output by the frequency amplification circuit is different from a waveform of the first excitation signal generated by the waveform generator, the first excitation signal output by the frequency amplification circuit is an ultrasonic band signal, and the first excitation signal generated by the waveform generator is an acoustic band signal), and amplifying the amplitude of the intermediate processing signal by the amplitude amplification circuit to obtain a second drive signal and outputting the second drive signal to the piezoelectric driver, wherein the first period and the second period do not intersect.

In some exemplary implementations, the first period and the second period may be cycled a plurality of times, however, embodiments of the present disclosure are not limited thereto. For example, assuming that the number of cycles is 2 times, the first period includes a period from 0 to t1 and a period from t2 to t3, and the second period includes a period from t1 to t2 and a period from t3 to t4, and 0<t1<t2<t3<t4.

In some exemplary implementations, the frequency amplification circuit includes: a frequency doubling circuit; and the frequency doubling circuit includes a multiplier circuit.

In some exemplary implementations, the waveform generator includes an audio chip.

The controller controls the waveform generator to generate an excitation signal, including:
controlling the audio chip by the controller to generate an excitation signal, which is an envelope-modulated carrier signal.

In some exemplary implementations, the frequency amplification factor of the frequency doubling circuit may be between 2 times and 10 times, and however, an embodiment of the present disclosure is not limited thereto.

In some exemplary implementations, the amplitude amplification factor of the amplitude amplification circuit may be between 2 times and 30 times, and however, an embodiment of the present disclosure is not limited thereto.

Those of ordinary skills in the art may understand that all or some of acts in the methods disclosed above, systems, functional modules or units in apparatuses may be implemented as software, firmware, hardware, and an appropriate combination thereof. In a hardware implementation mode, division of the function modules/units mentioned in the above description is not always corresponding to division of physical components. For example, a physical component may have multiple functions, or a function or an act may be executed by several physical components in cooperation. Some components or all components may be implemented as software executed by a processor such as a digital signal processor or a microprocessor, or implemented as hardware, or implemented as an integrated circuit such as an application specific integrated circuit. Such software may be distributed on a computer readable medium, and the computer readable medium may include a computer storage medium (or a non-transitory medium) and a communication medium (or a transitory medium). As known to those of ordinary skills in the art, a term computer storage medium includes volatile and nonvolatile, and removable and irremovable media implemented in any method or technology for storing information (for example, a computer readable instruction, a data structure, a program module, or other data). The computer storage medium includes, but is not limited to, a RAM, a ROM, an Electrically Erasable Programmable Read Only Memory (EEPROM), a flash memory or another memory technology, a Compact Disc Read Only Memory (CD-ROM), a Digital Versatile Disk (DVD) or another optical disk storage, a magnetic cartridge, a magnetic tape, magnetic disk storage or another magnetic storage apparatus, or any other medium that may be configured to store desired information and may be accessed by a computer. In addition, it is known to those of ordinary skill in the art that the communication medium usually includes a computer readable instruction, a data structure, a program module, or other data in a modulated data signal of, such as, a carrier wave or another transmission mechanism, and may include any information delivery medium.

Although implementations disclosed in the present disclosure are described as above, the described contents are only implementations which are used for facilitating understanding of the present disclosure, but are not intended to limit the present invention. Any skilled person in the art to which the present disclosure pertains may make any modification and variation in a form and details of implementation without departing from the spirit and scope of the present disclosure. However, the patent protection scope of the present invention should be subject to the scope defined in the appended claims.

1. A haptic feedback apparatus comprising: a controller, a waveform processor, a piezoelectric driver, and a touch panel, and the haptic feedback apparatus further comprising a virtual function region, wherein the controller comprises a waveform generator;
the touch panel is configured to detect touch position information of user interaction and output the touch position information to the controller;
the controller is configured to determine whether the touch position information is in the virtual function region, and control the waveform generator to generate an excitation signal and output the excitation signal to the waveform processor if the touch position information is in the virtual function region;
the waveform processor is configured to amplify the excitation signal and output the processed signal to the piezoelectric driver; and
the piezoelectric driver is configured to receive the processed signal and generate deformation to drive the touch panel to vibrate.

2. The haptic feedback apparatus of claim 1, wherein the excitation signal generated by the waveform generator comprises a first excitation signal and/or a second excitation signal, and a wavelength of the excitation signal generated by the waveform generator is within an audio band.

3. The haptic feedback apparatus according to claim 2, wherein the waveform processor comprises: an amplitude amplification circuit; and
the amplitude amplification circuit is provided between the waveform generator and the piezoelectric driver, and is configured to output a drive signal after amplifying an amplitude of the first excitation signal, and output the drive signal to the piezoelectric driver.

4. The haptic feedback apparatus according to claim 3, wherein the drive signal comprises a first drive signal, and the first drive signal has an amplitude amplification between 2 times and 30 times compared to the amplitude of the first excitation signal generated by the waveform generator.

5. The haptic feedback apparatus according to claim 3, wherein the drive signal comprises a first drive signal, a frequency of the first excitation signal generated by the waveform generator and a frequency of the first drive signal are between 50 Hz and 500 Hz, and the frequency of the first excitation signal generated by the waveform generator and the frequency of the first drive signal are the same.

6. The haptic feedback apparatus according to claim 3, wherein the waveform processor further comprises: a frequency amplification circuit; and
the frequency amplification circuit connects the waveform generator and the amplitude amplification circuit, and the frequency amplification circuit is configured to output the first excitation signal after amplifying a frequency of the second excitation signal generated by the waveform generator, and output the first excitation signal to the amplitude amplification circuit.

7. The haptic feedback apparatus according to claim 6, wherein a frequency of the first excitation signal output by the frequency amplification circuit is m times the frequency of the second excitation signal; wherein m is any value from 2 to 10.

8. The haptic feedback apparatus according to claim 6, wherein the drive signal comprises a second drive signal, and an amplitude of the second drive signal is n times the amplitude of the first excitation signal output by the frequency amplification circuit, wherein n is any value from 2 to 30.

9. The haptic feedback apparatus according to claim 8, wherein frequencies of the first excitation signal and the second drive signal output by the frequency amplification circuit are greater than 20 kHz.

10. The haptic feedback apparatus according to claim 5, wherein the frequency amplification circuit comprises: a frequency doubling circuit; and
the frequency doubling circuit comprises a multiplier circuit.

11. The haptic feedback apparatus according to claim 1, wherein the waveform generator comprises: an audio chip;
wherein the audio chip is configured to output the excitation signal, and the excitation signal is an envelope-modulated carrier signal.

12. The haptic feedback apparatus according to claim 1, wherein the haptic feedback apparatus comprises a cover plate, and the piezoelectric driver is provided on the cover plate.

13. The haptic feedback apparatus according to claim 1, wherein the virtual function region comprises a virtual function pattern region disposed on a cover plate, the virtual function pattern region is provided with one or more virtual function patterns, and the virtual function pattern comprises at least one of following patterns: a key, a progress bar, and a dial.

14. The haptic feedback apparatus according to claim 1, wherein the haptic feedback apparatus further comprises a display module, which comprises a display panel, and the display panel is used for displaying a human-computer interaction interface containing the virtual function region.

15. A haptic feedback method for a haptic feedback apparatus comprising a controller, a waveform processor, a piezoelectric driver and a touch panel, and the haptic feedback apparatus further comprising a virtual function region, wherein the controller comprises a waveform generator, and the haptic feedback method comprises:
detecting touch position information of user interaction through the touch panel, and outputting the touch position information to the controller;
determining whether the touch position information is in the virtual function region through the controller, and if the touch position information is in the virtual function region, controlling the waveform generator through the controller to generate an excitation signal and outputting the excitation signal to the waveform processor;
amplifying the excitation signal through the waveform processor and outputting the processed signal to the piezoelectric driver;
wherein the piezoelectric driver receives the processed signal and deforms, thereby driving the touch panel to vibrate.

16. The haptic feedback method according to claim 15, wherein the excitation signal generated by the waveform generator comprises a first excitation signal and/or a second excitation signal, and a wavelength of the excitation signal generated by the waveform generator is within an audio band.

17. The haptic feedback method according to claim 16, wherein the waveform processor comprises: an amplitude amplification circuit, which is provided between the waveform generator and the piezoelectric driver; and the amplifying the excitation signal through the waveform processor and outputting the processed signal to the piezoelectric driver, comprises:
outputting a drive signal after amplifying an amplitude of the first excitation signal by the amplitude amplification circuit, and outputting the drive signal to the piezoelectric driver.

18. The haptic feedback method according to claim 17, wherein the waveform processor further comprises: a frequency amplification circuit, which connects the waveform generator and the amplitude amplification circuit; and amplifying the excitation signal through the waveform processor and outputting the processed signal to the piezoelectric driver, further comprises:
outputting the first excitation signal after amplifying a frequency of the second excitation signal generated by the waveform generator through the frequency amplification circuit, and outputting the first excitation signal to the amplitude amplification circuit.
